(19) United States
(12) Patent Application Publication
(10) Pub. No.: US 2008/0033733 A1
(43) Pub. Date: Feb. 7, 2008

(54) MALE EVENINGWEAR ENSEMBLE AND METHOD

(76) Inventor: Lawrence J. Coates, Wyncote, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/461,823

(22) Filed: Aug. 2, 2006

(51) Int. Cl. G06Q 10/00

(52) U.S. Cl. 705/1

(57) ABSTRACT

A method of doing business in the eveningwear industry includes providing a line of male eveningwear attire including comfortable, jean cut pants having belt loops, contour belts and modular belt buckles that are removably attachable to the belts. The modular belt buckles are each provided with a display face that exhibits a distinctive and conspicuous visual characteristic, such as a color or a pattern that visually matches a woman's formal attire. A selection of a plurality of different types of the modular belt buckles are preferably made available, with each type exhibiting a different conspicuous distinctive visual characteristic on its display face. In addition, the line of male eveningwear attire may include shirts having distinctive plackets that have a darker appearance and adjacent areas of the shirt, so as to create an illusion of a tie with no tie being present. The male eveningwear attire may thus be marketed without ties, providing a significant competitive advantage.

### BACKGROUND OF THE INVENTION

1. Field of the Invention

This invention relates broadly to the field of formal or eveningwear attire. More specifically, the invention relates to a new eveningwear ensemble for males that is comfortable, economical to market and rent and is readily matchable to a woman's formal attire.

2. Description of the Related Technology

Eveningwear as the term is used herein refers to attire such as tuxedoes and accessories that is worn primarily for formal or ceremonial occasions such as proms, weddings and other black-tie functions. The marketing of eveningwear attire in the United States is dominated by formal wear rental businesses. For purposes of this document, eveningwear shall also be construed to include occupationally related formal wear (also known as careerwear), such as tuxedos that are worn by bartenders, waiters, other service sector employees and so forth.

Typically, eveningwear for a male, i.e. a boy or a man, will include a pair of pants, a matching jacket, a shirt, possibly a vest, a bowtie and possibly a cummerbund that is intended to be fastened about the waist. The pants and a matching jacket are typically dark-colored, usually black. The shirt is typically white and buttons in the front, and may have either buttons on the sleeve cuffs or holes to accommodate cuff links. The bowtie is also typically black. In some instances, the cummerbund or vest may be provided in different colors. In this way, the cummerbund or vest may be color coordinated with other articles.

Tuxedo pants are invariably designed to have a formal cut and to fit about the waist of a wearer. They almost always include a stiffened, reinforced waist area and do not have belt loops as they are not designed to be worn with a belt. In some instances, they may be worn with suspenders. Since most tuxedos are rented instead of owned, and since it is to the commercial benefit of formal wear rental businesses to minimize the number of inventory items to be rented, rental tuxedos are often ill fitting. In addition, many men today are not used to wearing pants that are styled as a formal or dress cut and find it uncomfortable to be wearing pants that are designed to be worn about the waist. Young men in particular are more comfortable with a pants cut that is intended to be worn about the hips, i.e. a jean cut.

The expense of keeping an adequate selection of the various available colors of accessories such as vests for a formal wear rental business is considerable. In addition, formal wear rental businesses suffer economically from any premature wear or damage that is suffered by male eveningwear attire as a result of stress that is placed on the clothing by a wearer who is uncomfortable or unfamiliar with it.

A need exists for an improved product line of male eveningwear attire and a method of marketing such attire that provides an improved experience for the wearer, a more economical ability for coordinating and matching with female attire, and improved margins for formal wear rental businesses.

### SUMMARY OF THE INVENTION

Accordingly, it is an object of the invention to provide an improved product line of male eveningwear attire and a method of marketing such attire that provides an improved experience for the wearer, a more economical ability for coordinating and matching with female attire, and improved margins for formal wear rental businesses.

In order to achieve the above and other objects of the invention, a method of providing male eveningwear attire according to a first aspect of the invention includes steps of ascertaining a first visual characteristic of a female's planned attire; selecting male eveningwear attire for a male who is planning to appear in association with the female at a social event, wherein the step of selecting male eveningwear attire includes selecting a belt buckle that has a second visual characteristic that is readily identifiable with the first visual characteristic of the female's planned attire.

An eveningwear ensemble for a male according to a second aspect of the invention includes a pair of eveningwear pants that have a plurality of belt loops; an eveningwear shirt; a belt; and a belt buckle.

According to a third aspect of the invention, a method of doing business in the eveningwear industry includes providing a line of male eveningwear attire that includes eveningwear pants having belt loops, belts and modular belt buckles that are constructed and arranged for removable attachment to the belts, the modular belt buckles having a display face that exhibits a distinctive visual characteristic, and wherein the method comprises providing a selection of a plurality of different types of the modular belt buckles, each type exhibiting a different distinctive visual characteristic on its display face.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a front elevational view of a male wearing an eveningwear ensemble that is configured according to a preferred embodiment of the invention;

FIG. 2 is a front elevational view of a male wearing an eveningwear ensemble according to a modified embodiment of the invention;

FIG. 3 is a photograph of a belt buckle according to one embodiment of the invention;

FIG. 4 is a photograph of a belt buckle according to an alternative embodiment of the invention;

FIG. 5 is a front elevational view of a belt buckle according to another alternative embodiment of the invention;

FIG. 6 is a side elevational view of the belt buckle that is shown in FIG. 5;

FIG. 7 is a top plan view of a belt constructed according to a preferred embodiment of the invention;

FIG. 8 is a front elevational view of the shirt that is constructed according to one embodiment of the invention;

FIG. 9 is a rear elevational view of the shirt that is depicted in FIG. 8;

FIG. 10 is a front elevational view of a shirt that is constructed according to an alternative embodiment of the invention;

FIG. 11 is a rear elevational view of the shirt that is depicted in FIG. 10;

FIG. 12 is a front elevational view of a shirt that is constructed according to an alternative embodiment of the invention;

FIG. 13 is a rear elevational view of the shirt that is depicted in FIG. 12;

FIG. 14 is a front elevational view of the shirt that is constructed according to yet another embodiment of the invention;

FIG. 15 is a rear elevational view of the sure that is depicted in FIG. 14;

FIG. 16 is a front elevational view of the shirt that is constructed according to another embodiment of the invention; and

FIG. 17 is a rear elevational view of the shirt that is constructed according to the embodiment of FIG. 16.

### DETAILED DESCRIPTION OF THE PREFERRED EMBODIMENT(S)

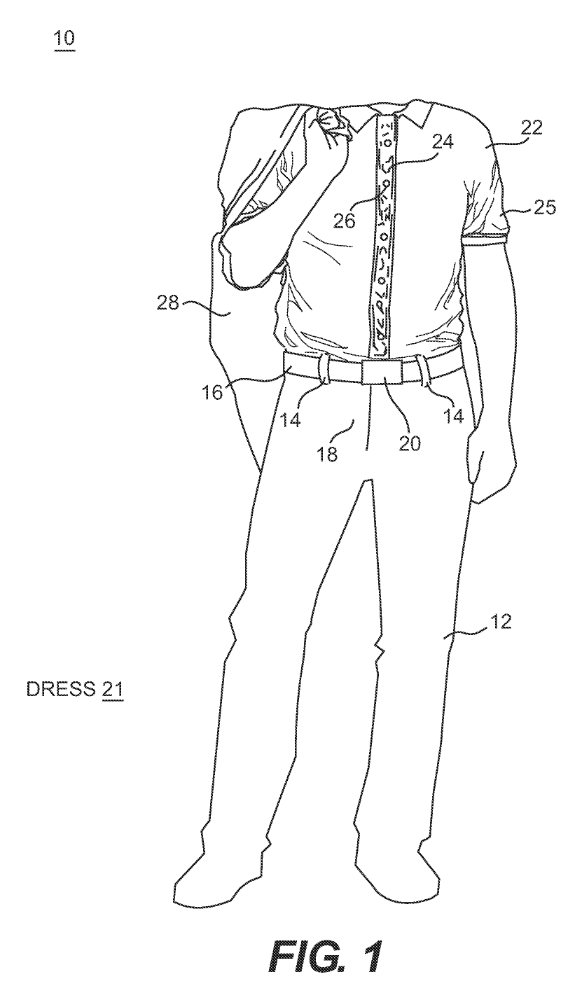

Referring now to the drawings, wherein like reference numerals designate corresponding structure throughout the views, and referring in particular to FIG. 1, an eveningwear ensemble 10 that is constructed according to a preferred embodiment of the invention includes a pair of pants 12 that has a plurality of belt loops 14, unlike conventional eveningwear pants that do not include belt loops and are not intended to be worn with a belt. Pants 12 preferably are configured in a jean cut, meaning that they are specifically cut to fit about the hips of a wearer, below the waist, rather than about the waist as is conventional in eveningwear. The pants 12 also preferably include a contoured waistband that is designed to be lower in the front than it is in the back. Pants 12 are also preferably fabricated out of a stretch fabric in order to ensure comfort for a wearer. The stretch fabric is preferably a woven fabric that includes a blend of elastic fibers, such as Lycra or spandex. The stretch fabric may also include artificial fibers such as polyester or nylon, or natural fibers such as cotton or wool.

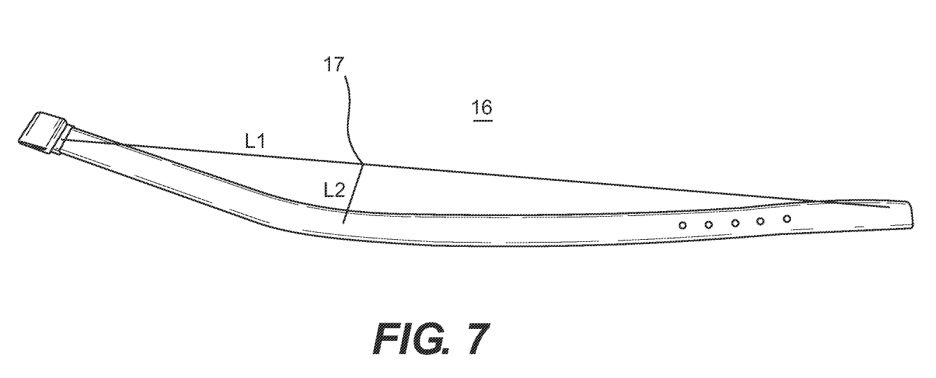

Eveningwear ensemble 10 further preferably includes a belt 16 that in the preferred embodiment is configured as a contour belt, as is depicted in FIG. 7. A contour belt has a distinct curve when laid flat, as may be seen in FIG. 7. This distinctive curve in the preferred embodiment substantially matches the curvature of the contoured waistband of the pants 12. The degree of curvature may be expressed as a ratio L2/L1, wherein L1 is the distance along a horizontal axis that intersects a centerline of the belt 16 at both ends of the belt 16, the distance L1 being measured between the end of belt 16 to which the belt buckle is to be attached to a location 17 on the horizontal axis that is even with where the curvature of the belt 16 reaches its greatest depth. The distance L2 is measured from location 17 to the centerline of the belt 16 where the curvature of the belt 16 reaches its greatest depth. Preferably the ratio L2/L1 is within a range of about 0.05 to about 0.35. More preferably, the ratio L2/L1 is within a range of about 0.07 to about 0.25. Most preferably, the ratio L2/L1 is within a range of about 0.10 to about 0.15. Within this most preferred range, contour belt 16 could be used or rented for use with eveningwear pants that have either a jean cut with a contour waistband or a conventional formal cut. The ability to rent belt 16 for either use would be of significant economic value to an eveningwear rental business.

Belt 16 may be fabricated from any conventional material or combination of materials, such as leather, fabric or vinyl or it may be constructed from an elastic material. It is preferably black, but could alternatively be white or any other preferred color.

A belt buckle 18 having a distinctive display face 20 is preferably removably attached to belt 16. According to one particularly advantageous feature of the invention, the distinctive display face 20 preferably exhibits a second visual characteristic that is matchable to a first visual characteristic that is external to said eveningwear ensemble 10. In one preferred embodiment of the invention, the first visual characteristic is color, and the article that is external to the eveningwear ensemble 10 is the attire of a female who is planning to appear in association with the wearer of the eveningwear ensemble 10 at a social event. For example, the color of the distinctive display face 20 may be selected to match the color of the bridesmaids' dresses 21 at a wedding. In another embodiment of the invention, the color of the distinctive display face 20 may be selected to match the official colors of a high school, prep school or college, or the theme colors of any other event. In another embodiment, the color of the distinctive display face 20 may be selected to match a theme color of a business, such as a restaurant, bar or casino.

The second visual characteristic that appears on the distinctive display face 20 could also incorporate visual characteristics other than color, such as texture, patterns, logos, or other designs. For example, display face 20 may be provided with the logo of an organization, a pattern resembling a national flag or it could be customized in order to commemorate an event at which the eveningwear ensemble 10 is intended to be worn, such as a wedding.

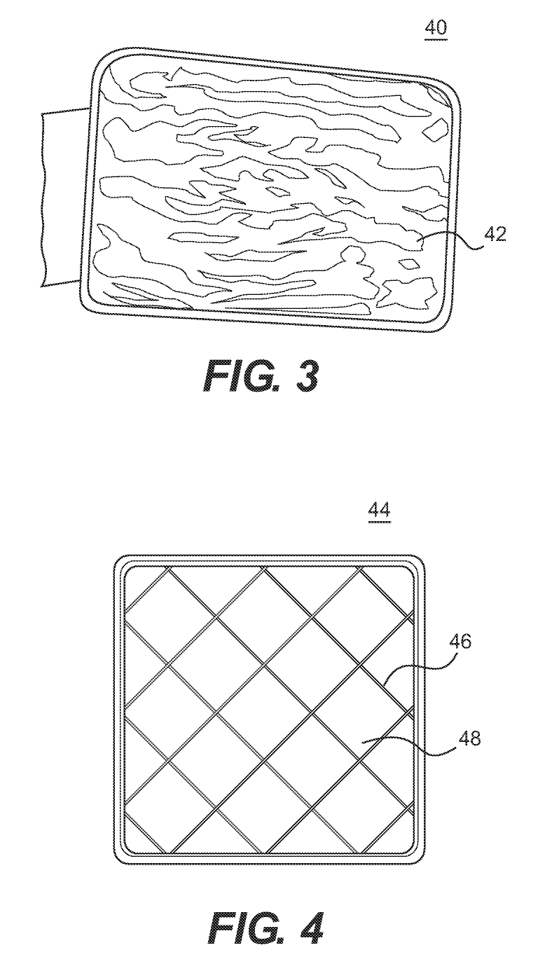

For example, the display face 42 of a belt buckle 40 constructed according to the embodiment of the invention that is depicted in FIG. 3 has a pearlized swirl pattern that is made up of more than one color. In addition to being inherently attractive, this embodiment of the invention permits the display face 42 to be matched to external articles that incorporate any of the colors or subcombinations of colors that have been used in the swirl pattern. An eveningwear rental business, for example, would find this an attractive characteristic because it would permit less inventory to be kept on hand.

FIG. 4 depicts a belt buckle 44 according to an alternative embodiment of the invention wherein the display face 46 is provided with ajacquard pattern 48. The jacquard pattern 48 could be made up of two colors, three colors or even more than three colors, which would permit the display face 46 to be visually matched to anyone of a variety of different colors of articles that are external to the eveningwear ensemble 10. It would also permit the jacquard pattern 48 to be matched to an article bearing a similar jacquard pattern.

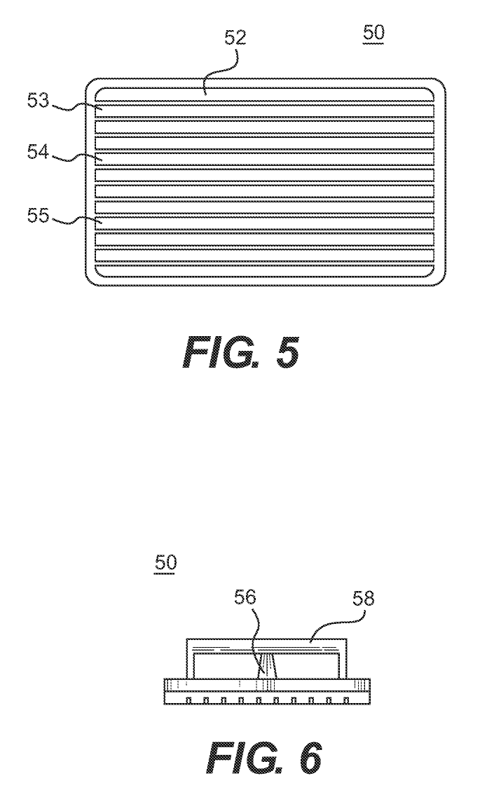

In the embodiment of FIGS. 5 and 6, a belt buckle 50 is provided with a display face 52 having a plurality of horizontal stripes 53 that are of a first color, a second plurality of horizontal stripes 54 that are of a second color and a third plurality of horizontal stripes 55 that are of a third color. Each of the three colors is different from either of the other two colors. Belt buckle 50 is designed to be removable from belt 16, and in the preferred embodiment includes a pawl 56 that is constructed and arranged to be set into a hole in the belt 16 and a bale 58 around which one end of the belt 16 is constructed and arranged to be looped.

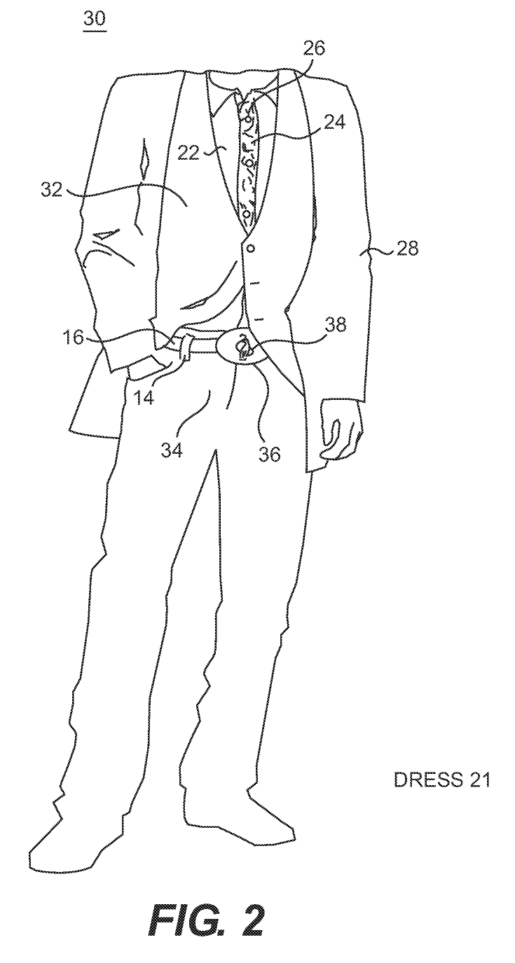

The belt buckle may have a display face that is rectangular, as shown in the embodiment of FIG. 1 and in the embodiments of FIGS. 3, 5 and 6, or square, as shown in the embodiment of FIG. 4. Alternatively, the belt buckle may have a distinctive oval shape, as shown in the embodiment that is depicted in FIG. 2. In the embodiment of FIG. 2, belt buckle 34 has an oval display face 36 that is provided with a distinctive pattern or logo 38. As another alternative, the belt buckle could be given a distinctive, irregular shape that is recognizable in association with a particular event, organization or affiliation.

Eveningwear ensemble 10 further preferably includes a shirt 22, which in the preferred embodiment includes short sleeves 24. Shirt 22 is preferably worn without a tie in the eveningwear ensemble 10, and as an alternative preferably includes a placket 24 that has a visual characteristic that is distinctive from surrounding areas of the shirt 22. Preferably, the placket 24 is darker than the surrounding areas of the shirt 22. In the preferred embodiment, the placket 24 is significantly darker than surrounding areas of the shirt 22, and is preferably black or nearly black while the surrounding areas of the shirt 22 are a light color, preferably white. This creates a vertical striping effect that is visually simulative of a tie. The placket 24 is preferably provided with a plurality of button holes through which shirt buttons 26 may be fastened. Shirt buttons 26 may be colored to match the color of the placket 24 in order to preserve the vertical striping effect in as unbroken a fashion as possible. Alternatively, the placket 24 could be distinctively lighter than surrounding areas of the shirt 22. The placket 24 could also alternatively be made so as to be detachable from the shirt 22, which would permit an eveningwear rental business to mix and match plackets having different patterns and/or colors to different shirt colors and patterns.

In an alternative embodiment, the placket 24 could be patterned and/or colored so as to visually match the display face 20 of the belt buckle 18.

Eveningwear ensemble 10 also preferably includes a jacket 28. As is shown in the embodiment of FIG. 2, eveningwear ensemble 10 may also include a vest 32. Eveningwear ensemble 10 also preferably includes a pair of shoes 30, which in the preferred embodiment are stylized as low-cut boots.

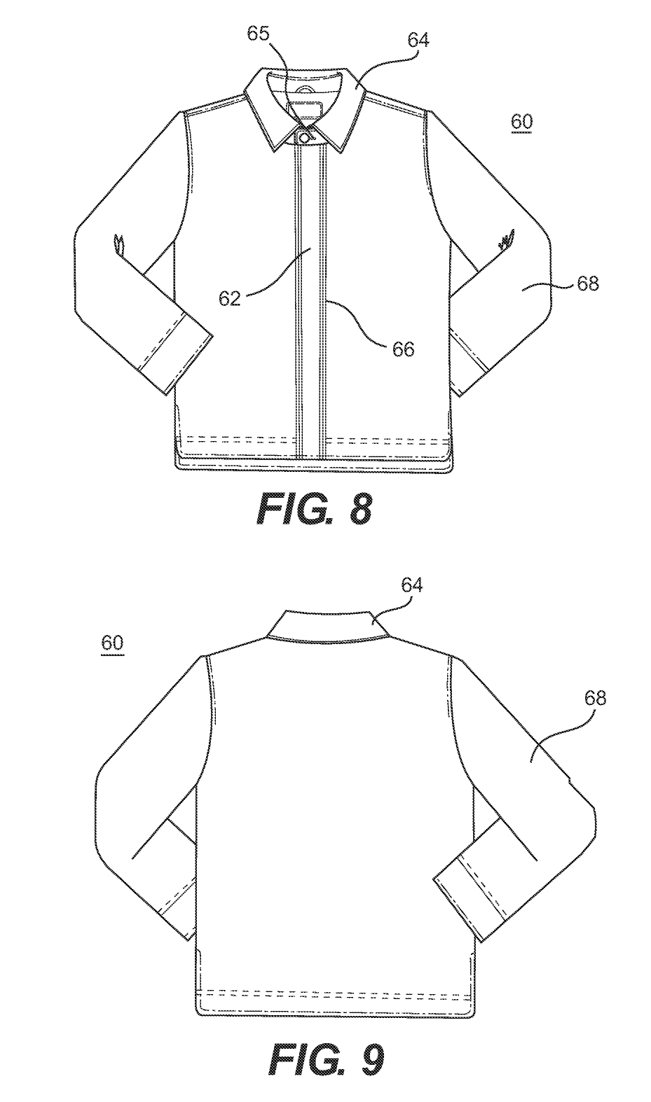

Referring now to FIGS. 8 and 9, a shirt 60 that is constructed according to an alternative embodiment of the invention is preferably fabricated from a stretch fabric as described above, such as a mercerized cotton stretch fabric. Shirt 60 includes a black placket 62 and a white collar 64. The placket 62 preferably includes a fly front, meaning that it has a flap 66 that covers the shirt buttons that are underneath the placket 62. The placket 62 preferably has a width that is substantially within a range of about 1 inch to about 3 inches, and that is most preferably about 1.75 inches. Shirt 60 also preferably has long sleeves 68. In addition, a distinctive collar stand 65 is provided beneath the collar 64 and above the placket 62 that is preferably given a coloration that matches the coloration of the placket 62.

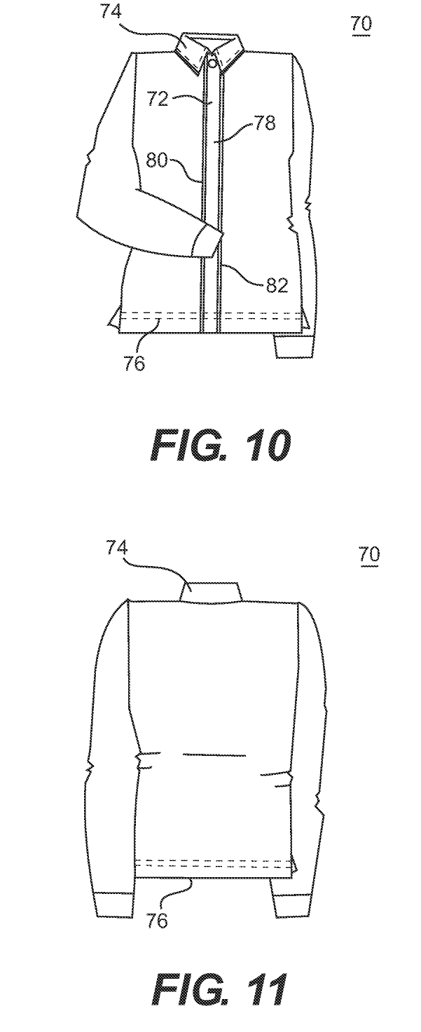

Referring now to FIGS. 10 and 11, a shirt 70 that is constructed according to a modified embodiment of the invention is also preferably fabricated from a stretch fabric as described above and includes a black or colored placket 72 that extends downwardly from collar 74 to a bottom hem 76 of the shirt 70. Placket 72 preferably includes a fly front having a flap 78 that is slightly narrower than the placket 72. In addition, distinctive piping 80, 82 is preferably provided on each side of the flap 78 so as to create an enhanced visual effect that is simulative of a tie. The piping 80, 82 is preferably fabricated from a fine fabric such as satin and is preferably substantially narrower than the width of the placket 72 and preferably provides a visual contrast with respect to both the placket 72 and the fabric and 84 of adjacent areas of the shirt 70. Each piping 80, 82 preferably has a width that is within a range of about 0.05 inches to about 0.25 inches.

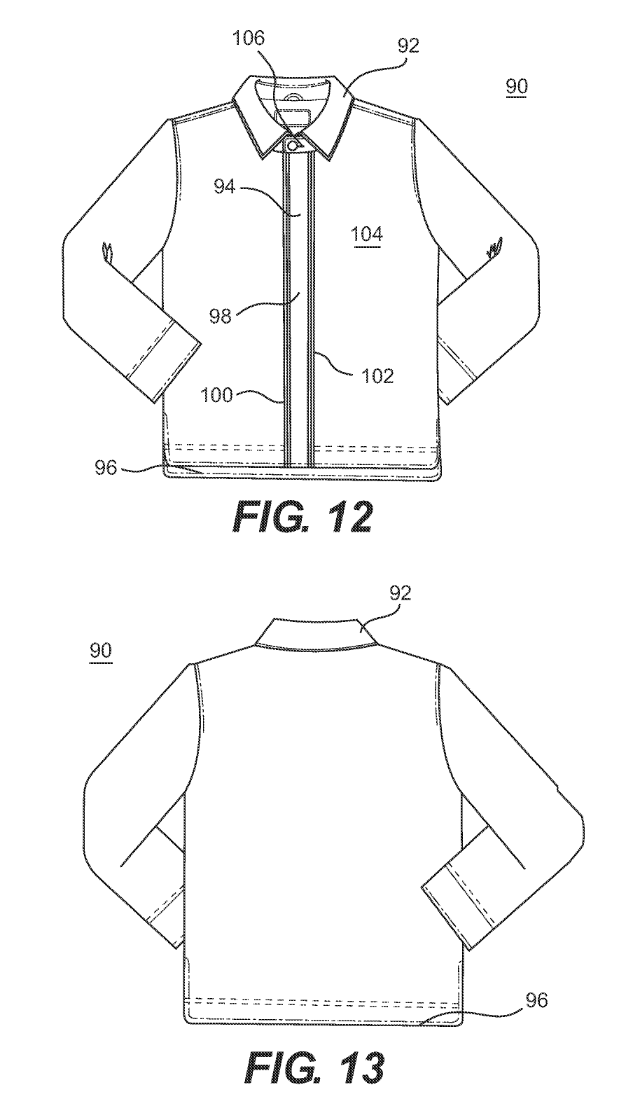

Looking now to FIGS. 12 and 13, a shirt 90 that is constructed according to another embodiment of the invention is also preferably fabricated from a stretch fabric as described above and includes a collar 92 and a placket 94 that extends downwardly from the collar 92 to a bottom hem 96 of the shirt 90. Placket 94 is preferably black and preferably includes a fly front having a flap 98 in order to cover the buttons of the shirt 90. In addition, distinctive piping 100, 102 is preferably provided on each side of the flap 98 so as to create an enhanced visual effect that is simulative of a tie. The piping 100, 102 is preferably fabricated from a fine fabric such as satin and is preferably substantially narrower than the width of the placket 94 and preferably provides a visual contrast with respect to both the placket 94 and the fabric 104 of adjacent areas of the shirt 90. Each piping strip 100, 102 preferably has a width that is within a range of about 0.05 inches to about 0.25 inches. In addition, a distinctive collar stand 106 is provided beneath the collar 92 and above the placket 94 that is preferably given a coloration that matches the coloration of the placket 94. Preferably, the placket 94, the collar 92 and the collar stand 106 are all black, but alternative coloration could be provided within the spirit of the invention.

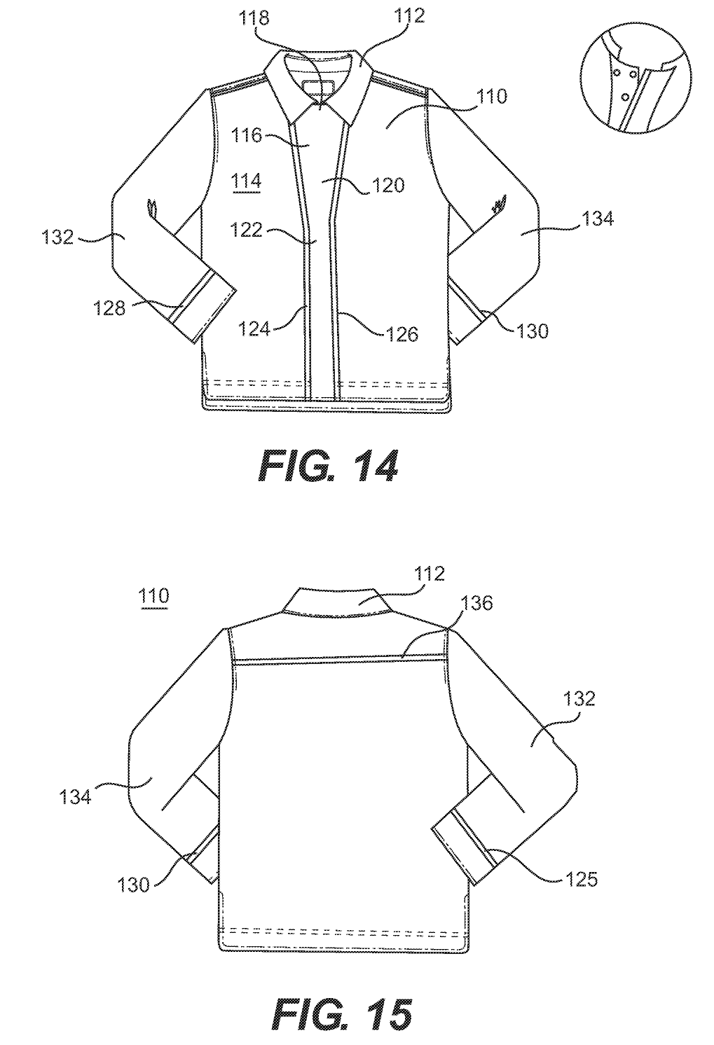

FIGS. 14 and 15 depict another embodiment of the invention typified by a shirt 110 having a collar 112 and a distinctive placket 114 that is configured to have variable width. In the illustrated embodiment, placket 114 includes an upper portion 116 that is tapered so as to be wider at its uppermost end 118 than it is at its lowermost end 120. This gives the upper portion 116 of the placket 114 a wedge shape. Placket 114 further includes a lower portion 122 that is preferably of a substantially constant width. The substantially constant width of the lower portion 122 is preferably within a range of about 1 inch to about 4 inches and is most preferably about 1.5 inches. The width of the lowermost end 120 of the upper portion 116 of the placket 114 is preferably the same as the width of the lower portion 122. The width of the uppermost end 118 of the upper portion 116 is preferably within a range of about 1.5 inches to about 5.5 inches, with a most preferred width of about 2.25 inches.

Contrast piping strips 124, 126 are preferably provided on each side of the distinctive placket 114. Piping strips 124, 126 are preferably colored, and the color selected may be specifically selected to match a first visual characteristic of something that is external to the eveningwear ensemble, such as the bridesmaids' dresses at a wedding. The contrast piping strips 124, 126 are preferably fabricated from a fine fabric such as satin. In addition, sleeved piping bands 128, 130 are preferably provided on each of the sleeves 132, 134 of the shirt 110. Piping bands 128, 130 are preferably although not necessarily matched in color and texture to the contrast piping strips 124, 126. Moreover, shoulder piping 136 that matches the sleeved piping bands 128, 130 and the contrast piping strips 124, 126 and is preferably constructed of a fine fabric such as satin may be provided on the back of the shirt 110, as is depicted in FIG. 15. Shoulder piping 136 is preferably styled as a horizontal length of fabric having a substantially constant width that extends between the sleeves 132, 134. The coloration of the main portion of the shirt 110 may be white, or it may be given a color that may be chosen to match something external to the eveningwear ensemble such as the bridesmaids' dresses at a wedding.

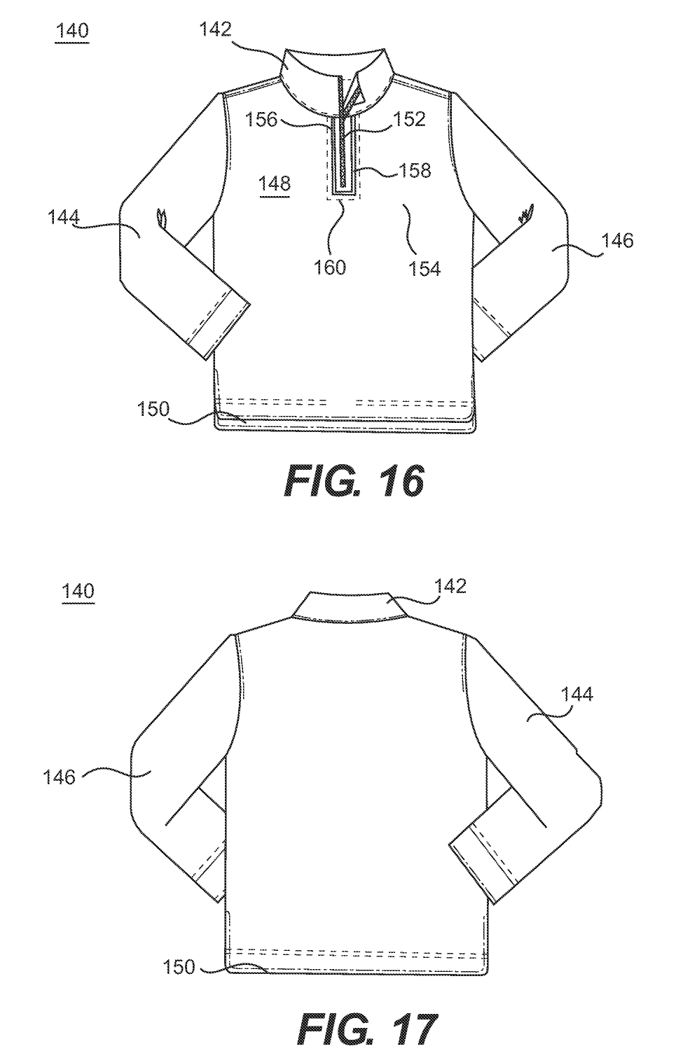

A shirt 140 that is constructed according to the invention depicted in FIG. 16 and 17 includes a collar 142 long sleeves 144, 146 and a zipper placket 148 that extends downwardly from the area of the collar 142 only a portion of the distance between the collar 142 and a bottom hem 150 of the shirt 140. A zipper 152 is provided in the zipper placket 148. In addition, distinctive piping is provided between the zipper placket 148 and the adjacent fabric 154 of the main body of the shirt 140. This distinctive piping includes first and second vertical piping strips 156, 158 and a horizontal piping strip 160 at the bottom of the zipper placket 148.

A method of providing male eveningwear attire according to one embodiment of the invention includes a first step of ascertaining a first visual characteristic of something that is external to the eveningwear ensemble 10 and a second step of selecting male eveningwear attire that includes a belt buckle that has a second visual characteristic that is readily identifiable with the first visual characteristic. In one particularly preferred embodiment of the invention, the first step is performed by ascertaining a first visual characteristic of a female's planned attire in the second step is performed by selecting male eveningwear attire by selecting a belt buckle that has a second visual characteristic that is readily identifiable with the visual characteristic of the female's planned attire. The belt buckle may be visually coordinated with other components of the eveningwear ensemble as well, such as a colored placket or piping as has been described above.

In one embodiment of the invention, the belt buckle may be customized for the occasion at which the eveningwear ensemble is intended to be worn. This customization could be coordinated by the eveningwear rental business as an additional service for profit. For example, the belt buckle could be customized with the name of a bride and a groom and the date of the wedding. Groomsmen and other attendees of the wedding wearing the eveningwear ensemble could arrange with the eveningwear rental business to purchase and retain the customized belt buckles as mementos of the occasion. Other articles such as key chains bearing the same pattern could be produced and sold as keepsakes as well.

Another aspect of the invention includes a method of selling or renting eveningwear for males in which a selection of the components of the eveningwear ensemble 10 as described above are kept at a retail location for rental or sale. The eveningwear retail establishment will not need to keep bow ties in stock, because the eveningwear ensemble 10 does not require a tie. In addition, the jean cut of the pants of the eveningwear ensemble 10 will ensure that renters of the eveningwear ensemble 10 are kept comfortable, particularly in the case of young men. This, particularly in combination with the use of stretch fabrics, will tend to reduce the amount of wear and damage that will be suffered by the rental clothing, which in turn will increase the service life of the rental clothing and improve profit margins for the eveningwear rental business. By stocking belt buckles that have more than one component color or pattern, the number of necessary belt buckle inventory items is kept to a minimum, which also optimizes profits.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A method of providing male eveningwear attire that is worn primarily for formal or ceremonial occasions such as proms, weddings and other black-tie functions, comprising:
ascertaining a first visual characteristic of a human female's planned dress, said first visual characteristic comprising a color;
selecting male eveningwear attire for a male who is planning to appear in association with the human female at a formal or ceremonial occasion selected from the group consisting essentially of proms, weddings and other black-tie functions, and wherein said step of selecting male eveningwear attire comprises
selecting a belt buckle that has a second visual characteristic that is readily identifiable with said color of said first visual characteristic of said human female's planned dress; and wherein
said belt buckle is constructed and arranged to be quickly attachable and removable from a belt.

2. (canceled)

3. A method of providing male evening wear attire according to claim 1, wherein said second visual characteristic comprises a color that substantially matches said color of said first visual characteristic.

4. A method of providing male eveningwear attire according to claim 1, wherein said first visual characteristic further comprises a pattern.

5. A method of providing male eveningwear attire according to claim 4, wherein said second visual characteristic comprises a pattern that is identifiable with said pattern of said first visual characteristic.

6. A method of providing male eveningwear attire according to claim 5, wherein said second visual characteristic comprises a pattern that matches said pattern of said first visual characteristic.

7-8. (canceled)

9. A method of providing male eveningwear attire according to claim 1, wherein said step of selecting male eveningwear attire for a male is performed by an eveningwear rental service.

10. (canceled)

11. A method of providing eveningwear attire according to claim 1, wherein said belt buckle has a display face, and wherein said second visual characteristic is provided on said display face.

12. A method of providing eveningwear attire according to claim 11, wherein said belt buckle is removably mounted to a belt, and wherein said display face has a vertical dimension that is substantially larger than a vertical dimension of said belt.

13. A method of providing eveningwear attire according to claim 1, wherein said step of selecting male eveningwear attire further comprises selecting a shirt having a placket, and wherein said placket is shaded substantially darker than adjacent areas of said shirt, whereby an illusion of a tie is created.

14. A method of providing eveningwear attire according to claim 13, wherein said step of selecting male eveningwear attire is further performed so that no tie is selected.

15-29. (canceled)

30. A method of providing eveningwear attire according to claim 1, further comprising a step of attaching a belt to said belt buckle, and wherein said belt is a contour belt.

31. A method of providing eveningwear attire according to claim 1, further comprising a step of wearing said eveningwear attire to a formal or ceremonial occasion selected from the group consisting essentially of proms, weddings and other black-tie functions.

32. A method of providing male eveningwear attire that is worn primarily for formal or ceremonial occasions such as proms, weddings and other black-tie functions, comprising:
ascertaining a first visual characteristic of a human female's planned dress, said first visual characteristic comprising a color;
selecting male eveningwear attire for a male who is planning to appear in association with the human female at a formal or ceremonial occasion selected from the group consisting essentially of proms, weddings and other black-tie functions, wherein said step of selecting male eveningwear attire comprises:
selecting a belt buckle that has a second visual characteristic that is readily identifiable with said first visual characteristic of said human female's planned dress and
selecting a belt; and wherein
said belt buckle is constructed and arranged to be quickly attachable and removable from the belt and includes a pawl that is constructed and arranged to be set into a hole in the belt and a bale around which one end of the belt is constructed and arranged to be looped.

33. A method of providing eveningwear attire according to claim 32, wherein said belt is a contour belt.

34. A method of providing eveningwear attire according to claim 33, wherein said step of selecting male eveningwear attire further comprises selecting pants, said pants having a jean cut that is cut to fit about the hips of a wearer, below the waist.

35. A method of providing eveningwear attire according to claim 34, wherein said step of selecting male eveningwear attire further comprises selecting pants that are fabricated from a stretch fabric.

36. A method of providing eveningwear attire according to claim 32, wherein said step of selecting male eveningwear attire further comprises selecting pants, said pants having a jean cut that is cut to fit about the hips of a wearer, below the waist.

37. A method of providing male eveningwear attire that is worn primarily for formal or ceremonial occasions such as proms, weddings and other black-tie functions, comprising:
ascertaining a first visual characteristic of a human female's planned dress, said first visual characteristic comprising a color;
selecting male eveningwear attire for a male who is planning to appear in association with the human female at a formal or ceremonial occasion selected from the group consisting essentially of proms, weddings and other black-tie functions, wherein said step of selecting male eveningwear attire comprises:
selecting a belt, said belt being a contour belt;
selecting a belt buckle that has a second visual characteristic that is readily identifiable with said color of said human female's planned dress, said belt buckle being constructed and arranged to be quickly attachable and removable from the belt; and
selecting pants, said pants having ajean cut that is cut to fit about the hips of a wearer, below the waist.

38. A method of providing eveningwear attire according to claim 37, wherein said step of selecting male eveningwear attire further comprises selecting a belt buckle that includes a pawl that is constructed and arranged to be set into a hole in the belt and a bale around which one end of the belt is constructed and arranged to be looped.

39. A method of providing eveningwear attire according to claim 37, wherein said step of selecting male eveningwear attire further comprises selecting pants that are fabricated using a stretch fabric.
